(19) United States
(12) Patent Application Publication
(10) Pub. No.: US 2013/0143728 A1
(43) Pub. Date: Jun. 6, 2013

(54) Method Of Forming A Crosslinked Superabsorbent Polymer On A Substrate And Uses Thereof

(71) Applicants: Christopher Mark Lyons, Lichfield (GB); Gavin Leslie Morland, Sheerness (GB)

(72) Inventors: Christopher Mark Lyons, Lichfield (GB); Gavin Leslie Morland, Sheerness (GB)

(73) Assignee: H&R CHEMPHARM (UK) LTD., Tipton (GB)

(21) Appl. No.: 13/638,926

(22) PCT Filed: Jan. 26, 2011
(86) PCT No.: PCT/GB2011/050120

§ 371 Date: Feb. 19, 2013

(30) Foreign Application Priority Data
Apr. 1, 2010 (GB) 1005571.3

(51) Int. Cl. B01J 20/32

(52) U.S. Cl. CPC B01J 20/3225
USPC 502/4; 502/402

(57) ABSTRACT

A crosslinked superabsorbent polymer can be formed on a nonwoven or woven substrate by a method comprising:
a) providing an aqueous composition having a pH >7, e.g. ≧pH 8, comprising a dispersion of a sodium or potassium salt of a hydrophilic organic polymer comprising carboxyl functionality and having a weight average molecular weight of at least 200,000 (according to ASTM D4001-93(2006)), a base having a boiling point no greater than the boiling point of water, and a water soluble crosslinking agent capable of crosslinking the polymer in the absence of the base;
b) providing a nonwoven or woven substrate;
c) coating said nonwoven or woven substrate with said aqueous composition;
d) heating the coated substrate to a temperature above the boiling point of water to volatilize the base, initiate crosslinking of the polymer, and remove the water, so as to form the crosslinked superabsorbent polymer on the nonwoven or woven substrate. The product formed by this method is useful as a water-impermeable membrane in a geomembrane or in an underground or sub-marine cable.

The present invention concerns a method of forming a crosslinked superabsorbent polymer on a nonwoven or woven substrate and uses thereof.

### BACKGROUND

Crosslinked superabsorbent polymers (SAPs) are well known and are polymers that can absorb and retain large amounts of water relative to their own mass. The largest use of SAPs, typically derived from crosslinking of sodium and potassium salts of hydrophilic organic polymers, is in a variety of hygiene products, such as diapers, sanitary napkins and adult protective underwear.

Such crosslinked superabsorbent polymers have also been used for blocking water penetration in underground power or communications cables, as horticultural water retention agents, in geomembranes and in the control of spill and waste aqueous fluids.

Many applications utilise the SAPs in the form of dried powders. However, powders can be difficult to handle, so it is beneficial to provide the SAP as a coating on a nonwoven or woven substrate, for example as disclosed in U.S. Pat. No. 6,287,679, U.S. Pat. No. 6,319,558, WO-A-0192433, US-A-2003/0124350, U.S. Pat. No. 5,998,312, US-A-2004/0059071, U.S. Pat. No. 5,213,893 and U.S. Pat. No. 6,284,367.

Coated glass-fibre based tapes and yarns have been manufactured by coating the woven glass fibre substrate with an aqueous dispersion, comprising a potassium salt of high molecular weight poly(acrylic acid), triethanolamine base, and ammonium zirconium carbonate crosslinking agent, and then drying the coated nonwoven or woven at temperatures typically in excess of 200° C., so as to form the crosslinked superabsorbent polymer on the nonwoven or woven glass fibre substrate. This method of manufacture requires high energy consumption, due to the high temperatures employed to dry the coating (a composition is considered to be dry when it contains no more than 1000 ppm water). In an attempt to reduce the energy consumed to dry the coating, it has been proposed to make more concentrated dispersions, which comprise less water, but these more concentrated dispersions can suffer from instability and may form gels over time. It has also been suggested to lower the drying temperature of the aqueous composition but, whilst the coating when formed may have appropriate mechanical performance indicative of complete and effective crosslinking, it has been found that water-uptake performance deteriorates over time, such as over a number of months, thus rendering the coated substrates unsuitable for long term applications, such as underground or submarine cabling and geomembranes.

It is an object of the present invention to provide a more eco-friendly process for manufacturing SAP coated nonwoven or wovens, by reducing energy consumption in the manufacturing process, without causing a significant detrimental effect on long term water-uptake performance.

The present invention in its various aspects is as set out in the accompanying claims.

In a first aspect, the present invention provides a method of forming a crosslinked superabsorbent polymer on a nonwoven or woven substrate, said method comprising:
a) providing an aqueous composition having a pH >7, e.g. ≧pH 8, comprising a dispersion of a sodium or potassium salt of a hydrophilic organic polymer comprising carboxyl functionality and having a weight average molecular weight of at least 200,000 (according to ASTM D4001-93(2006)), a base having a boiling point no greater than the boiling point of water, and a water soluble crosslinking agent capable of crosslinking the polymer in the absence of the base;
b) providing a nonwoven or woven substrate;
c) coating said nonwoven or woven substrate with said aqueous composition;
d) heating the coated substrate to a temperature above the boiling point of water but preferably no greater than 150° C. to volatilize the base, initiate crosslinking of the polymer, and remove the water, so as to form the crosslinked superabsorbent polymer on the nonwoven or woven substrate.

Preferably, the hydrophilic organic polymer is a homopolymer or copolymer comprising polymerized units of methacrylic acid or acrylic acid, and is more preferably poly(acrylic acid).

Preferably, the base is an organic base having a boiling point no greater than the boiling point of water, such as triethylamine.

Preferably, the crosslinking agent is a zirconium compound, such as ammonium zirconium carbonate. Ammonium zirconium carbonate is a stabilised alkaline solution containing anionic zirconium species with bridging hydroxyl groups with carbonate groups bonded to the zirconium. It is known that zirconium reacts strongly with carboxyl groups forming strong bonds whilst hydrogen bonding occurs weakly with hydroxyl groups. Crosslinking of linear hydrophilic organic polymers comprising carboxyl functionality causes the polymer chain to uncoil which allows more water to associate with the polymer chain. Removal of water and carbon dioxide during a drying stage drives the crosslinking reaction to completion due to the generation of reactive zirconium cations.

Preferably, the nonwoven or woven substrate is an organic substrate comprising natural fibres such as cotton and/or synthetic fibres such as polyethylene, polypropylene, polyethylene terephthalate and/or polyamide e.g. nylon. The invention is particularly suitable for providing products of synthetic fibres, as the temperatures employed in the prior art process tend to be higher than the melting point of such fibres.

The amount of aqueous composition used to coat the substrate may be sufficient to provide a dried weight of 1-1000 gm⁻² crosslinked superabsorbent polymer on the substrate.

Preferably, the coated substrate is heated to no greater than 150° C., more preferably no more than 140° C., and even more preferably no more than 130° C. Use of such significantly lower temperatures provides a reduction in energy consumption whilst, surprisingly, not having a significant detrimental effect on the long term water-uptake performance of the coated nonwoven or woven. By “not having a significant detrimental effect on the long term water-uptake performance of the coated nonwoven or woven”, we mean that the water-uptake performance of the SAP coated nonwoven or woven is not significantly decreased over the expected working life time of the end product comprising the coated nonwoven or woven substrate. For example, a geomembrane designed to have a working lifetime of at least 20 years, or a submarine cable designed to have a working life time of at least 30 years.

In another aspect, the present invention provides an aqueous composition having a pH in the range of 8-10 and comprising:

15-35 wt % alkali metal salt of poly(acrylic acid), preferably a K⁺ salt of poly(acrylic acid) which preferably has a molecular weight of from 250,000 to 20,000,000 e.g. 300,000 to 1,000,000,

0.1-0.3 wt % organic base having a boiling point no greater than the boiling point of water, e.g. triethylamine, and

1-3 wt % crosslinking agent,

based upon the wt of the aqueous composition. The aqueous composition may further comprise other ingredients typically employed in such compositions, for example 0.5-3 wt % polyethyelene glycol and/or 0.5-3 wt % Fischer-Tropsch wax emulsion.

In another aspect, the present invention provides a water-impermeable barrier comprising a crosslinked superabsorbent polymer on a nonwoven or woven substrate obtained or obtainable by the method of the first aspect. In one embodiment, the water-impermeable barrier is suitable for use in a geomembrane sealing system, for waterproofing surfaces in hydraulic and civil engineering, where the crosslinked superabsorbent polymer on a nonwoven or woven is preferably in the form of a swelling fleece. In another embodiment the water-impermeable barrier is suitable for blocking water penetration in an underground or submarine cable, where the crosslinked superabsorbent polymer on a nonwoven or woven is preferably in the form of a tape.

The invention in its various embodiments shall now be further described by way of exemplification only:

Electrical and communication cables are very sensitive to moisture. Moisture ingress can occur due to damage to the outer sheathing of the cable. In such cases, water can migrate long distances inside the cable and cause damage to considerable lengths of the cable. To help prevent this, a SAP coated nonwoven or woven, is used between the cable core(s) and the outer protective sheathing. If a hole occurs in the outer protective sheathing, water causes swelling of the SAP coated nonwoven or woven. The swelling pressure of the swelled SAP closes the hole and so prevent the further spread of water.

The invention can be used in telecommunication or energy cables to help prevent moisture ingress. The invention can be coated on to various supporting materials such as yarns, tapes, and non-wovens, which is incorporated around the core of the cable and underneath the outer sheath. The SAP-coated fabric is typically wrapped around sheathed conductors of copper telecommunication copper cables, or fibre tubes inside optical fibre telecommunication cables, or sheathed conductors of energy cables.

Accelerated aging tests were performed to check for any decrease in water uptake over time. The invention was dried at 120° C. and then held at 55° C. for 7 weeks and tested for swell rate and capacity in deionised water. No decrease in swell rate or capacity was observed. Water uptake is measured by the increase in height caused by swell when the invention in its activated form is exposed to an excess of water.

Swell height (μm)

| Time at 55° C. | 1 min | 3 mins | 10 mins |
|---|---|---|---|
| Guideline minimum limits | 1500 | 4000 | 7000 |
| 0 days | 2600 | 5100 | 7600 |
| 19 days | 2600 | 5200 | 7500 |
| 36 days | 2400 | 4900 | 7400 |
| 49 days | 2300 | 5100 | 7500 |

We claim:

1. A method of forming a crosslinked superabsorbent polymer on a nonwoven or woven substrate, said method comprising:
a) providing an aqueous composition having a pH >7, e.g. ≧pH 8, comprising a dispersion of a sodium or potassium salt of a hydrophilic organic polymer comprising carboxyl functionality and having a weight average molecular weight of at least 200,000 (according to ASTM D4001-93(2006)), a base having a boiling point no greater than the boiling point of water, and a water soluble crosslinking agent capable of crosslinking the polymer in the absence of the base;
b) providing a nonwoven or woven substrate;
c) coating said nonwoven or woven substrate with said aqueous composition; and
d) heating the coated substrate to a temperature above the boiling point of water to volatilize the base, initiate crosslinking of the polymer, and remove the water, so as to form the crosslinked superabsorbent polymer on the nonwoven or woven substrate.

2. The method as claimed in claim 1, wherein the hydrophilic organic polymer is a homopolymer or copolymer comprising polymerized units of methacrylic acid or acrylic acid.

3. A The method as claimed in claim 2, wherein the hydrophilic organic polymer is poly(acrylic acid).

4. The method as claimed in claim 1, wherein base is an organic base.

5. The method as claimed in claim 4, wherein the base is triethylamine.

6. The method as claimed in claim 1, wherein the crosslinking agent is a zirconium compound.

7. The method as claimed in claim 6, wherein the zirconium compound is ammonium zirconium carbonate.

8. The method as claimed in claim 1, wherein the nonwoven or woven substrate is an organic substrate comprising natural fibres, such as cotton, and/or synthetic fibres, such as polyethylene, polypropylene, polyethylene terephthalate and/or polyamide fibres e.g. nylon fibres.

9. A The method as claimed in claim 1, wherein the aqueous composition has a pH in the range of 8-10 and comprises:
15-35 wt % alkali metal salt of poly(acrylic acid),
0.1-0.3 wt % organic base having a boiling point no greater than the boiling point of water, and 1-3 wt % crosslinking agent,
based upon the wt of the aqueous composition.

10. A The method as claimed in claim 9, wherein the aqueous composition further comprises:
0.5-3 wt % polyethyelene glycol (having a molecular wt of 600 to 1400) and 0.5-3 wt % Fischer-Tropsch wax emulsion.

11. The method as claimed in claim 1, wherein in step d) the coated substrate is heated to no more than 150° C.

12. The method as claimed in claim 1, wherein the amount of aqueous composition used to coat the substrate is sufficient to provide a dried weight of 1-1000 gm⁻² crosslinked superabsorbent polymer on the substrate.

13. Use of the product formed by the method as claimed in claim 1 as a water-impermeable barrier in a geomembrane.

14. Use of the product formed by the method as claimed in claim 1 as a water-impermeable barrier in an underground or submarine cable.
